(19) United States
(12) Patent Application Publication
(10) Pub. No.: US 2020/0071535 A1
(43) Pub. Date: Mar. 5, 2020

(54) FLUIDICALLY APPLICABLE VAPOR RETARDER

(71) Applicant: BASF SE, Ludwigshafen am Rhein (DE)

(72) Inventors: Eva GUENTHER, Trostberg (DE); Georg DAXENBERGER, Trostberg (DE); Bernhard FEICHTENSCHLAGER, Trostberg (DE); Ekkehard JAHNS, Ludwigshafen (DE); Gerhard ALBRECHT, Prien am Chiemsee (DE); Burkhard WALTHER, Oldenburg (DE); Nikolaus NESTLE, Ludwigshafen (DE); Anoop GUPTA, Trostberg (DE)

(73) Assignee: BASF SE, Ludwigshafen am Rhein (DE)

(21) Appl. No.: 16/610,648

(22) PCT Filed: May 4, 2018
(86) PCT No.: PCT/EP2018/061462

§ 371 Date: Nov. 4, 2019

(30) Foreign Application Priority Data
May 5, 2017 (EP) 17169682.6

(51) Int. Cl. C09D 5/00; E04B 1/76; E04F 13/08

(52) U.S. Cl. CPC C09D 5/00; E04F 13/0875; E04B 1/7675

(57) ABSTRACT

The application relates to a moisture-variable protective layer having an s_{d} value at a relative air humidity of 10% and a temperature of 12 to 35° C. at least a factor of 5.0 higher than the s_{d} value at a relative air humidity of 90% and a temperature of 12 to 35° C., where the moisture-variable protective layer has been applied in liquid form by means of a coating composition, to a process for production thereof, to an insulation material and an insulation system comprising the moisture-variable protective layer, and to the use of a moisture-variable protective layer according to the invention in an insulation system which is free of support constructions and other heat bridges that penetrate the insulation layer, such as solid dowels or anchors, or as a coating on an insulation render.

The present invention relates to a moisture-variable protective layer, to a process for production thereof, to an insulation material and an insulation system including the moisture-variable protective layer, and to the use of the moisture-variable protective layer.

Thermal insulation of building shells is playing an ever greater role with regard to the insulation both of the roofs and of the walls. Insulation on the outside of the buildings is desirable, but not always possible. There is often simply no space available for the purpose if the buildings, for example, directly adjoin public space, for example roads or pathways. It is also possible that reasons of monument protection etc. prevent external insulation.

In the abovementioned cases, the insulation then has to take place on the inside of the buildings. It should be noted here that, in the case of internal insulation, there can be formation of condensation on the inside of the existing wall (according to the climatic region), which cannot be completely prevented. Corresponding moisture management via the insulation system is then required. This can be achieved by moisture-variable layers which, depending on the air humidity of the surrounding air, have a different water vapor diffusion-equivalent air layer thickness (s_{d} value). With increasing insulation performance, the condensation problem is aggravated, meaning that the moisture-variable layers must improve their performance. At the same time, insulation systems on the inside of buildings, whether on the wall or in roof insulation, must be of minimum thickness with simultaneously high insulation performance in order to minimize the loss of space resulting from the insulation.

Typically, in interior insulation, the insulation material is present on the existing wall (fixed, for example, by means of adhesive mortar) and the moisture-variable layer on the side of the insulation material remote from the existing wall.

Film systems as moisture-variable layer, as described, for example, in WO 2013/128114, have the disadvantage that there is no adhesion on the film. In order to be able to use such films, a support construction is typically required, for example made of wood or metal, which constitutes an unwanted heat bridge. Even if the film could be bonded to the insulation material, further layers that are typically present, for example reinforcement mortars, fine render etc., do not stick to the film, and so a further subconstruction, for example made of wooden boards and gypsum plasterboard, is required, which demands further space and constitutes a major construction project.

Moreover, the usability of films in the case of uneven surfaces is limited since the films are not adaptable to any desired substrates. Moreover, bonds and component connections of films (adhesive bonds) in the case of larger areas always constitute a weak point in relation to quality of execution and permanence.

A moisture-variable protective layer lacking the abovementioned disadvantages is therefore desirable.

The present invention provides a moisture-variable protective layer having the characteristic feature of an s_{d} value at a relative air humidity of 10% and a temperature of 12 to 35° C. at least a factor of 5.0 higher than the s_{d} value at a relative air humidity of 90% and a temperature of 12 to 35° C., where the moisture-variable protective layer has been applied in liquid form by means of a coating composition.

Preferably, the moisture-variable protective layer has the characteristic feature of an s_{d} value at a relative air humidity of 10% and a temperature of 16 to 26° C. at least a factor of 5.0 higher than the s_{d} value at a relative air humidity of 90% and a temperature of 16 to 26° C., where the moisture-variable protective layer applied in liquid form by means of a coating composition.

The factor is satisfied when the measurement is satisfied at a relative air humidity of 90% and a relative air humidity of 10% at any temperatures within the range specified; the factor is preferably satisfied when the measurement is effected at a relative air humidity of 90% and a relative air humidity of 10% at the same temperature.

More preferably, the moisture-variable protective layer has the characteristic feature of an s_{d} value at a relative air humidity of 10% and a temperature of 23° C. at least a factor of 5.0 higher than the s_{d} value at a relative air humidity of 90% and a temperature of 23° C., where the moisture-variable protective layer applied in liquid form by means of a coating composition.

It has been found that, surprisingly, the moisture-variable protective layer of the invention also has good adhesion to rockwool etc. and forms a continuous film (light microscope). At the same time, further layers that are typically applied on the inside, for example reinforcement mortars, render etc., have good adhesion to the moisture-variable protective layer, such that support constructions etc. are unnecessary. Moreover, the necessity of using a film is completely eliminated, which enables heat bridge-free and optionally thinner insulation systems.

Typically, the moisture-variable protective layer composed of the coating composition is applied directly to the insulation material or, if present, to a coating of the insulation material. There is therefore typically no requirement for a separate carrier layer, for example fleece etc., to which the coating composition is first applied, with subsequent further use of this composite. The moisture-variable protective layer is therefore preferably applied without using a carrier layer.

Carrier materials are, for example, fleece, paperboard and paper, and textile membranes, for example grids and meshes.

As mentioned above, the moisture-variable protective layer has the characteristic feature of an s_{d} value at a relative air humidity of 10% and a temperature of 12 to 35° C., preferably 16 to 26° C., more preferably 23° C., at least a factor of 5.0 higher than the s_{d} value at a relative air humidity of 90% and a temperature of 12 to 35° C.

Typically, the s_{d} value at a relative air humidity of 10% and a temperature of 12 to 35° C., preferably 16 to 26° C., more preferably 23° C., is at least 0.5 m, preferably between 0.5 m and 25.0 m, more preferably between 5.0 m and 25.0 m, even more preferably between 5.0 and 15.0 m and especially preferably between 5.0 m and 10.0 m.

The s_{d} value at a relative air humidity of 90% and a temperature of 12 to 35° C., preferably 16 to 26° C., more preferably 23° C., is typically between 0.01 m and 4.5 m, preferably between 0.01 m and 2.5 m, more preferably between 0.01 m and 1.5 m and especially preferably between 0.01 m and 1.0 m.

The coating composition preferably comprises a polymer.

The coating composition is preferably in the form of a water-based polymer dispersion, of a reactive resin or of a solution polymer.

The polymer is preferably selected from, and more preferably consists of, polyvinyl alcohol, ethylene-vinyl alcohol copolymers, partly hydrolyzed polyvinyl acetate, partly hydrolyzed ethylene-vinyl acetate copolymers, polyvinylbutyral, homo- or copolymers of (meth)acrylates, vinyl ethers, polystyrene, styrene acrylates, styrene-butadiene, butadiene, polyvinylamines, polyamides, polyamino acids, terpolymers of ethylene, vinyl alcohol and (meth)acrylates, terpolymers of ethylene, vinyl alcohol and vinyl ethers, reactive resins based on polyurethane, epoxides, acrylates or polyurea. Particularly preferred reactive resins are polyurethanes based on MDI prepolymers and polyureas based on MDI prepolymers and/or polyetheramine.

In the present application, the expression “(meth)acrylate” encompasses both acrylates and methacrylates.

The polymers may optionally have been crosslinked.

In one embodiment, the coating composition is a water-based polymer dispersion and comprises
10% to 90% by weight of polymer, preferably 20% to 70% by weight of polymer, more preferably 25% to 60% by weight of polymer
10% to 90% by weight of water, preferably 80% to 30% by weight of water
0% to 80% by weight of filler and pigments, preferably 10% to 60% by weight of filler and pigments
0% to 10% by weight of rheology additives, based on the water-based polymer dispersion.

If the composition comprises further components as well as polymer and water, the proportion of polymer and water is reduced in equal portions. If, for example, 20% by weight of filler and pigments is present, the proportion of polymer and water is 10% to 70% by weight in each case.

In this embodiment, the polymer preferably comprises, and more preferably consists of, polyvinyl alcohol, ethylene-vinyl alcohol copolymers, partly hydrolyzed polyvinyl acetate, partly hydrolyzed ethylene-vinyl acetate copolymers, polyvinylbutyral, (meth)acrylate homo- or copolymers, vinyl ethers, polystyrene, styrene acrylates, styrene-butadiene, butadiene, polyamides, polyamino acids, terpolymers of ethylene, vinyl alcohol and (meth)acrylates, terpolymers of ethylene, vinyl alcohol and vinyl ethers; especially preferred are partly hydrolyzed polyvinyl acetate, (meth)acrylate homo- or copolymers and polyamides.

The polymer is preferably selected from
polyamide copolymers,
n-butyl acrylate/acrylonitrile copolymers,
styrene-butadiene copolymers,
ethylene-vinyl acetate copolymers, and
styrene-acrylate copolymers.

In this embodiment, the coating composition may comprise up to 10% by weight of organic solvents. These organic solvents, if present, are typically selected from alcohols, esters, ethers and ketones, but also oils such as linseed oil or mineral oil fractions. Reactive solvents are also possible, for example crosslinking and polymerizing systems.

In an alternative embodiment, the coating composition is a reactive resin and comprises at least 70% by weight of polymer, preferably at least 85% by weight of polymer and most preferably at least 95% by weight of polymer.

Further customary additives, for example biocides, wetting agents, color pigments, plasticizers, for example phthalates, such as dioctyl phthalate, or adipates, benzoates and esters of cyclohexanedicarboxylic acids etc., defoamers and/or foam formers and other additives, for example rheology modifiers, may likewise be present. Typically, the proportion thereof, if present, is not more than 20% by weight. Smaller amounts according to the use are known to the person skilled in the art.

The abovementioned fillers and pigments include color pigments.

In this alternative embodiment, the reactive resins are preferably based on polyurethane, epoxides, acrylates or polyurea. Particularly preferred reactive resins are polyurethanes based on MDI prepolymers and polyureas based on MDI prepolymers and/or polyetheramine.

In a further alternative embodiment, the coating composition is a solution polymer and comprises at least 10% by weight of polymer, preferably at least 20% by weight of polymer and most preferably at least 30% by weight of polymer.

A solution polymer is typically the solution of a polymer in an organic solvent. Water is present only in a small amount in a solution polymer, typically below 10.0% by weight.

Suitable solvents for solution polymers in the construction sector are known from the prior art. Typically, their boiling point at 1.0 bar does not exceed 250° C., preferably 200° C.

The solvent content is typically up to 80% by weight, preferably 30% to 80% by weight, more preferably 50% to 80% by weight.

Suitable solution polymers are, for example, polyamides, partly hydrolyzed vinyl acetates, polyamino acids, polyurethanes, polyureas, polystyrene, styrene acrylates, styrene-butadienes, ethylene-vinyl alcohol copolymers, homo- or copolymers of (meth)acrylates, acrylate copolymers, terpolymers of ethylene, vinyl alcohol and (meth)acrylates, terpolymers of ethylene, vinyl alcohol and vinyl ethers.

Further customary additives, for example biocides, wetting agents, color pigments, plasticizers, for example phthalates, such as dioctyl phthalate, or adipates, benzoates and esters of cyclohexanedicarboxylic acids etc., defoamers and/or foam formers and other additives, for example rheology modifiers, may likewise be present. Typically, the proportion thereof, if present, is not more than 20% by weight. Smaller amounts according to the use are known to the person skilled in the art.

Unless the contrary is explicitly stated, all embodiments of the present invention are described further hereinafter.

The invention is further directed to a process for producing a moisture-variable protective layer according to the present invention on an insulation material, wherein the moisture-variable protective layer is applied in liquid form by means of a coating composition to the insulation material or, if present, to a coating of the insulation material.

The application of the moisture-variable protective layer may precede or follow the securing of the insulation material, for example to the wall or building roof.

For example, even in the course of manufacture of the insulation material, the moisture-variable protective layer may be applied at the factory, which enables solvent recovery, for example, and defined process conditions, for example pressure, temperature and humidity. The coating may also precede application at the construction site if, for example, drying of the coating in the spaces to be insulated is undesirable, for example owing to poor ventilation.

The open abutting edges that are unavoidable on application of the moisture-variable protective layer prior to the securing of the insulation material can then be closed with small amounts of coating composition—with or without reinforcement inlay—or by means of special sealing adhesive tapes. They are preferably closed with small amounts of coating composition.

In the case of application after securing, abutting edges are automatically closed.

The application of liquid coating systems, including 2-component systems, is known from the prior art.

Since the application can also be effected by painting with a painting roller according to the coating composition, the moisture-variable protective layer according to the present invention is also suitable for do-it-yourself products.

An insulation material according to the present invention typically has a thickness of 1 to 30 cm and/or a thermal conductivity lambda λ of <100 mW/m·K, preferably 5 to 70 mW/m·K, especially preferably 5 to 60 mW/m·K. Especially preferred are a thickness of 1 to 15 cm and/or a thermal conductivity lambda of 5 to 40 mW/·K, and more preferred a thickness of 1 to 10 cm and/or a thermal conductivity lambda of 5 to 29 mW/m·K.

More preferably, an insulation material according to the present invention typically has a thickness of 1 to 30 cm and a thermal conductivity lambda λ of <100 mW/m·K, preferably 5 to 70 mW/m·K, especially preferably 5 to 60 mW/m·K. Especially preferred are a thickness of 1 to 15 cm and a thermal conductivity lambda of 5 to 40 mW/m√K, and more preferred a thickness of 1 to 10 cm and a thermal conductivity lambda of 5 to 29 mW/m·K.

In a particularly preferred embodiment, the insulation material has a thickness of 1 to 7 cm and a thermal conductivity lambda of 5 to 29 mW/m·K.

Suitable insulation materials are, for example, mineral wool, insulation renders, aerogel insulation render, organic and inorganic aerogels, for example Slentex® or Slentite®, PUR, PIR, resol resin insulation board, renders, specifically insulation renders, glass wool, calcium silicate board, gypsum-based insulation materials, wood wool, wood fiber insulation board, cellulose, sheep's wool, cork and expanded polystyrene (EPS), but also insulating building materials such as tile, porous concrete, wood. The moisture level averaged over the year is thus typically kept lower in the insulation material, which increases the effective insulation effect.

Preferred insulation materials are aerogel insulation render, organic and inorganic aerogels, for example Slentex®, Slentite®.

In one embodiment, the moisture-variable protective layer is the outer layer on the room side. In this embodiment, the moisture-variable protective layer replaces the “normal” wall color or the moisture-variable protective layer is used for painting over with breathable paints. One advantage of this embodiment is that cracks in the moisture-variable protective layer can be immediately recognized and repaired.

In an alternative embodiment, the moisture-variable protective layer is applied at the factory and functions as an adhesive bond between two layers, for example between individual plies of the insulation material. This protects the moisture-variable protective layer from mechanical damage or damage by environmental effects.

In addition, the protective layer may be mounted between insulation material and further functional layers, for example for mechanical strengthening/reinforcement, mounting aids such as position markers, hook-and-loop strips, anti-slip surface, sensors such as break-in sensors, smoke sensors, and thus functions simultaneously as adhesive bond.

A further embodiment is the combination of an abovementioned insulation material with a liquid-applicable vapor barrier which is applied to another material, not necessarily an insulating material. Examples of such a material are a gypsum plasterboard, wood fiberboard, gypsum fiberboard, fiber cement board, paper, fleece and wooden board.

The invention is further directed to an insulation system including an insulation material, wherein the insulation material includes a moisture-variable protective layer according to the present invention, where the moisture-variable protective layer has been applied in liquid form to the insulation material by means of a coating composition and the insulation system further includes a further layer applied to the moisture-variable protective layer, selected from indoor render, paint, tiles, untreated natural stone, mosaics, paneling and wallpaper.

The insulation system is preferably characterized in that the insulation system is free of support constructions and other heat bridges that penetrate the insulation layer, such as solid dowels or anchors. The use of heat bridge-free dowels for thermal insulation systems would be possible.

An insulation material according to the present invention typically has a thickness of 1 to 30 cm and/or a thermal conductivity lambda λ of <100 mW/m·K, preferably 5 to 70 mW/m·K, especially preferably 5 to 60 mW/m·K. Especially preferred are a thickness of 1 to 15 cm and/or a thermal conductivity lambda of 5 to 40 mW/m·K, and more preferred a thickness of 1 to 10 cm and/or a thermal conductivity lambda of 5 to 29 mW/m·K.

More preferably, an insulation material according to the present invention typically has a thickness of 1 to 30 cm and a thermal conductivity lambda λ of <100 mW/m·K, preferably 5 to 70 mW/m·K, especially preferably 5 to 60 mW/m·K. Especially preferred are a thickness of 1 to 15 cm and a thermal conductivity lambda of 5 to 40 mW/m·K, and more preferred a thickness of 1 to 10 cm and a thermal conductivity lambda of 5 to 29 mW/m·K.

In a particularly preferred embodiment, the insulation material has a thickness of 1 to 7 cm and a thermal conductivity lambda of 5 to 29 mW/m·K.

Suitable insulation materials are, for example, mineral wool, aerogel insulation render, organic and inorganic aerogels, for example Slentex® or Slentite®, PUR, PIR, resol resin insulation board, renders, specifically insulation render, glass wool, calcium silicate board, gypsum-based insulation materials, wood wool, wood fiber insulation board, cellulose, sheep's wool, cork and expanded polystyrene (EPS), but also insulating building materials such as tile, porous concrete, wood. The moisture level averaged over the year is thus typically kept lower in the insulation material, which increases the effective insulation effect.

Preferred insulation materials are aerogel insulation render, organic and inorganic aerogels, for example Slentex®, Slentite®.

A further embodiment is the combination of an abovementioned insulation material with a liquid-applicable vapor barrier which is applied to another material, not necessarily an insulating material. Examples of such a material are a gypsum plasterboard, wood fiberboard, gypsum fiberboard, fiber cement board, paper, fleece, wooden board.

The present invention further relates to the use of a moisture-variable protective layer according to the present invention in an insulation system free of support constructions.

The present invention further relates to the use of a moisture-variable protective layer according to the present invention as coating on an insulation render.

The present invention further relates to the use of a coating composition comprising a polymer as defined above for production of a moisture-variable protective layer by means of liquid application. The liquid is preferably applied without use of a carrier layer. The coating composition is preferably a water-based polymer dispersion and the water-based polymer dispersion comprises the following:
10% to 90% by weight of polymer
10% to 90% by weight of water
0% to 80% by weight of filler and pigments, preferably 30% to 80% by weight of fillers and pigments,
0% to 10% by weight of rheology additives, based on the water-based polymer dispersion.

### EXAMPLES

Measurement Methods:

Water Capor Diffusion-Equivalent Air Layer Thickness (s_{d})

Transmission of water vapor is described by what is called the s_{d} value, the “water vapor diffusion-equivalent air layer thickness”. The measurement was conducted as described in DIN EN ISO 12572:2001 by means of a Gintronic GraviTest 6400 by the gravimetric principle. The test area was 50 cm²; the number of specimens per measurement was 6. The thickness of the specimens was variable and is reported in the respective measurements. In order to be able to determine a more exact moisture dependence of water vapor permeability, adjusted test conditions were used. Measurements were made at least two moisture contents, and in individual cases also at three moisture contents. Water vapor-tight pots were filled with a desiccant or salt solution, sealed with the specimen and placed in an environment with air humidity controlled by the instrument (measurement chamber). The pot fillings are 50 g of calcium chloride desiccant for 0% RH, 60 g of water on sponge for 100% RH, and saturated aqueous magnesium chloride solution for 40% RH. The relative air humidity in the measurement chamber was 20% at 0% in the pot (average of 10%), 80% at 100% in the pot (average of 90%), and 60% at 40% in the pot (average of 50%). In each of the graphs, the average is plotted on the X axis.

To measure the switching characteristics, self-contained films were produced by casting or by painting or knife-coating onto PTFE. The thickness of the specimens was determined at five positions distributed over the test area by means of a Hanatek FT3 precision measurement device and the average was used as the result.

| | Brief designation | Long designation/type/recipe | Production of the films |
|---|---|---|---|
| Mat. No. 1 | Polyamide | 26% by weight of PA6.66.613 polyamide copolymer (e.g. Ultramid ® 1 C | The material was applied to the |
| | solution | from BASF) solution in ethanol:water 95:5 vol %. | polyolefin film and then dried at 40° C. |
| | | | for 16 hours. |
| Mat. No. 2 | Acrylate color | A mixture of 390 g of a dispersion of an n-butyl acrylate/acrylonitrile | The material was applied to the |
| | formulation 1 | copolymer 91% by weight:9% by weight (solids content 60%), 365 g of | polyolefin film by spatula and dried at |
| | | pigment and filler (TiO2 and calcium carbonate, weight ratio 10:19), 174 g | 25° C. for 12 hours. |
| | | of water and customary additives. | |
| Mat. No. 3 | Styrene- | Styrene-butadiene dispersion-based material comprising | The material was applied to the |
| | butadiene | 40-50% styrene-butadiene dispersion | polyolefin film by spatula and dried at |
| | dispersion | 40-50% ground chalk/marble | 25° C. for 12 hours. |
| | | 0-1% additives such as biocides, wetting agents, defoamers | |
| | | 0-1% plasticizer | |
| | | 0-1% thickener (acrylate) | |
| | | 0-1% water | |
| Mat. No. 4 | EVA solution | Ethylene-vinyl acetate copolymer (EVA) containing 27 mol % of ethylene | The material was applied to the |
| | polymer | (hydrolysis level 100%), 16% in DSMOt | polyolefin film and then dried at 70° C. |
| | | | for 48 hours. |
| Mat. No. 5 | EVA emulsion | 302 g of a dispersion of a vinyl acetate/ethylene copolymer (e.g. | The material was applied to the |
| | paint formulation | Mowilith ® LDM 1871 from Celanese) 80% by weight: 20% by weight | abovementioned film and then dried |
| | | (solids content 52-54%), 480 g of pigments and fillers (TiO₂, talc, kaolin, | at 25° C. for 16 hours. |
| | | calcium carbonate weight ratio 11:2:1:10), 160 g of water and customary | |
| | | additives. | |
| Mat. No. 6 | Polyamide | PA6.66.613 polyamide copolymer (e.g. Ultramid ® 1 C from BASF) | This material was poured into a PP |
| | dispersion | secondary dispersion 20% in water | mold and then dried at 25° C. for 16 |
| | | | hours. |
| Mat. No. 7 | Acrylate color | 320 g of acrylate dispersion for facade paints (e.g. Acronal ® Edge 6295 | The material was applied to the |
| | formulation 2 | from BASF), 480 g of pigments and fillers (TiO₂, talc, kaolin, calcium | abovementioned film and then dried |
| | | carbonate weight ratio 11:2:1:10), 160 g of water and customary | at 25° C. for 16 hours. |
| | | additives. | |
| Mat. No. 8 | Acrylate color | 320 g of a dispersion of an acrylate polymer (e.g. Acronal ® ECO 6270 | The material was applied to the |
| | formulation 3 | from BASF) (solids content 50% by weight), 480 g of pigments and fillers | abovementioned film and then dried |
| | | (TiO₂, talc, kaolin, calcium carbonate weight ratio 11:2:1:10), 160 g of | at 25° C. for 48 hours. |
| | | water and customary additives. | |

Subsequently, the s_{d} values were determined. The results are listed in the table below. The measurements were made at 23° C. and the specified relative air humidity.

| | sd value in m at relative air humidity of | | |
|---|---|---|---|
| Mat. No. | 10% | 50% | 90% |
| 1 | 18.3 | 7.8 | 0.2 |
| 2 | 1.4 | | 0.2 |
| 3 | 13.7 | 9.0 | 0.6 |
| 4 | 6.7 | | 0.3 |
| 5 | 28.9 | | 0.1 |
| 6 | 5.7 | | 0.2 |
| 7 | 9.8 | 10.0 | 0.2 |
| 8 | 108 | | 0.2 |

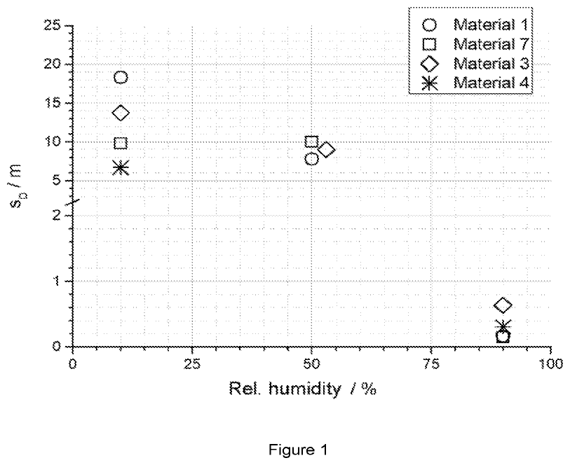

The results for materials 1, 3, 4 and 7 are shown in FIG. 1.

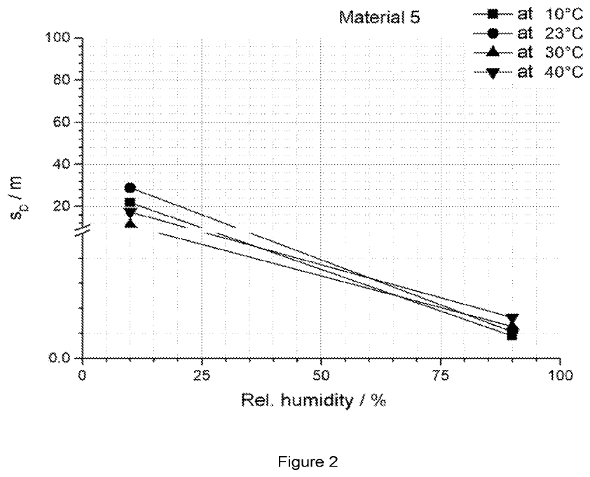

In the case of material 5, the temperature dependence of switching characteristics was additionally measured; the results are shown in FIG. 2. It was found that this material has virtually zero temperature dependence in the relevant range of 10-40° C. and is thus also suitable for interiors without constant temperature control.

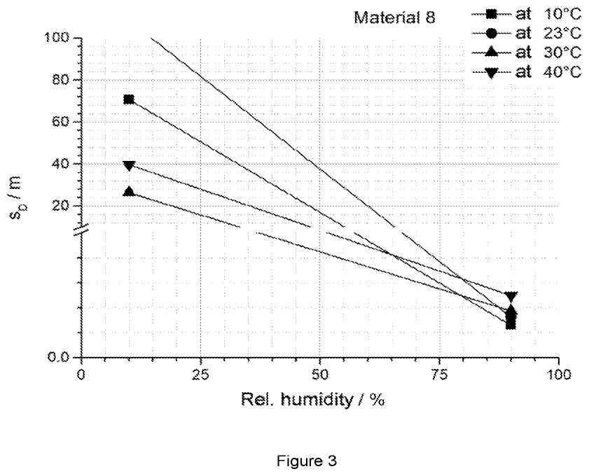

The results for material 8 are shown in FIG. 3. This material, by contrast, has distinct dependence in switching characteristics on temperature. At low temperatures, the switching characteristics are much more pronounced (denser when dry, more open when wet) than at high temperatures, which assists the drying-out of the moisture in the fabric of the still unheated building and can be advantageous in seasonally used spaces.

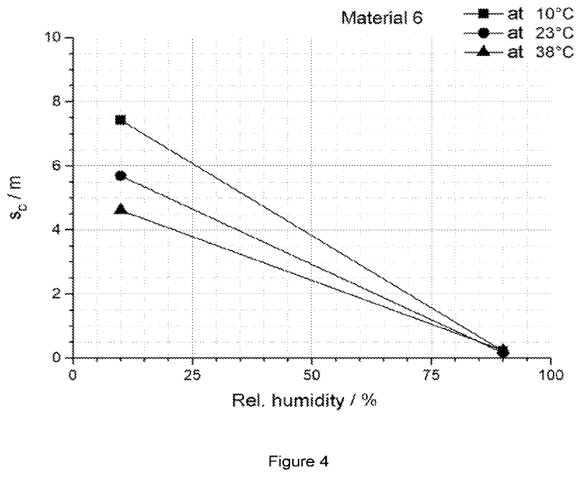

The results for material 6 are shown in FIG. 4. This material shows temperature dependence primarily under dry conditions.

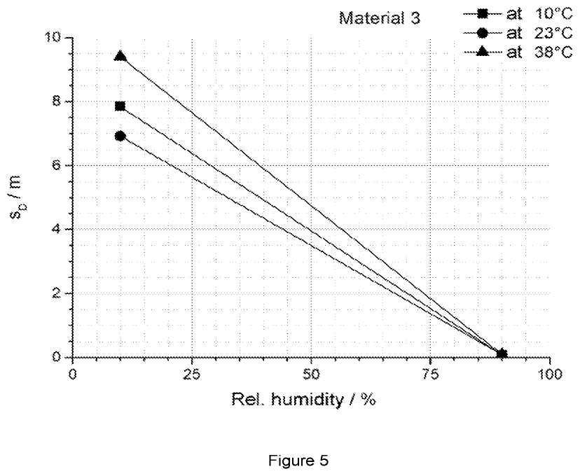

The results for material 3 are shown in FIG. 5.

In addition, the applicability of the compositions that follow to various substrates was examined.

### Example 1

100 g of Ultramid 1C was dissolved in 500 g of ethanol:water 9:1 and applied to the substrates listed in table 1.

TABLE 1

| Substrate | | Ready for overcoat | | | | |
|---|---|---|---|---|---|---|
| (specimen | Specimen | (cured tack-free) | Applicable thickness | Number of | | Applicable by |
| dimensions | thickness | (under laboratory | on use | operations | Material required | (roller, brush, spatula, |
| 25 × 25 cm) | [cm] | conditions) | (continuous surface!) | needed | g/m² total | coating knife, etc.) |
| Mineral wool | 2 | 2 hours | about | 2 | A1: about 1200 g/m² | Brush |
| sheet | | | 0.4 mm | | A2: about 300 g/m² | |
| (Coverrock ®) | | | | | Average: 750-800 g/m² | |
| Aerogel | 1 | 2 hours | about | 2 | A1: about 800 g/m² | Brush |
| insulation | | | 0.3 mm | | A2: about 400 g/m² | |
| material | | | | | Average: 600-650 g/m² | |
| (Slentex ®) | | | | | | |
| Gypsum | 1.2 | about 15 | <0.1 mm | 2 | about 70 g/m² | Roller |
| plasterboard | | minutes | | | per coat | |
| Gypsum | 1 | about 15 | <0.1 mm | 2 | about 100 g/m² | Roller |
| fiberboard | | minutes | | | per coat | |
| Oriented strand | 1 | about 15 | <0.1 mm | 2 | about 90 g/m² | Roller |
| board | | minutes | | | per coat | |

The coating adheres to all substrates including Coverrock (mineral wool sheet), which is fibrous rockwool, and forms a homogeneous film when viewed under the microscope. In the case of rockwool, the fibers were coated and uniform wetting was likewise achieved.

### Example 2

Material 7 was applied to the substrates listed in table 1.

TABLE 2

| Substrate | | Ready for overcoat | [symbol] | | | Applicable by |
|---|---|---|---|---|---|---|
| (specimen | | (cured tack-free) | thickness on use | | | (roller, brush, |
| dimensions | Specimen | (under laboratory | (continuous | Number of | Material required | spatula, coating |
| 25 × 25 cm) | thickness [cm] | conditions) | [symbol] | operations needed | g/m² total | knife, etc.) |
| Mineral wool | 2 | 4 hours, 5 | about | 2 | A1: about 1100 g/m² | Brush |
| (Rockwool ® for | | better | 0.4 mm | | A2: about 550 g/m² | |
| roofs) | | | | | Average: 800-850 g/m² | |
| Aerogel | 1 | 4 hours, 5 | about | 2 | A1: about 1000 g/m² | Brush |
| insulation | | better | 0.3 mm | | A2: about 700 g/m² | |
| board | | | | | Average: about | |
| (Slentex ®) | | | | | 850 g/m² | |
| Gypsum board | 1.2 | about 15 | <0.1 mm | 1, 2 | about 100 g/m² | Roller |
| | | minutes | | better | per coat | |
| Gypsum | 1 | about 20 | about | 1, 2 | A1: about 180 g/m² | Roller |
| fiberboard | | minutes | 0.1 mm | better | A2: about 110 g/m² | |
| | | | | | Average: 140-150 g/m² | |
| Oriented strand | 1 | about 20 | about | 1, 2 | about 160 g/m² | Roller |
| board | | minutes | 0.1 mm | better | per coat | |

[symbol]

indicates data missing or illegible when filed

Here too, there was good wetting of the surface under the microscope, including on rockwool.

1. A moisture-variable protective layer having an s_{d} value at a relative air humidity of 10% and a temperature of 12 to 35° C. at least a factor of 5.0 higher than the s_{d} value at a relative air humidity of 90% and a temperature of 12 to 35° C., wherein the moisture-variable protective layer is applied in liquid form by means of a coating composition.

2. The moisture-variable protective layer according to claim 1, wherein the moisture-variable protective layer is applied without using a carrier layer.

3. The moisture-variable protective layer according to claim 1, wherein the coating composition comprises a polymer.

4. The moisture-variable protective layer according to claim 3, wherein the coating composition is in the form of a water-based polymer dispersion, a reactive resin-based polymer dispersion or a solution polymer-based polymer dispersion.

5. The moisture-variable protective layer according to claim 3, wherein the polymer is selected from the group consisting of polyvinyl alcohol, ethylene-vinyl alcohol copolymers, partly hydrolyzed polyvinyl acetate, partly hydrolyzed ethylene-vinyl acetate copolymers, polyvinylbutyral, homo- or copolymers of (meth)acrylates, vinyl ethers, polystyrene, styrene acrylates, styrene-butadiene, butadiene, polyvinylamines, polyamides, polyamino acids, terpolymers of ethylene, vinyl alcohol and (meth)acrylates, terpolymers of ethylene, vinyl alcohol and vinyl ethers, reactive resins based on polyurethane, epoxides, (meth)acrylate polymers, and polyurea.

6. The moisture-variable protective layer according to claim 3, wherein the polymer is selected from the group consisting of
polyamide copolymers,
n-butyl acrylate/acrylonitrile copolymers,
styrene-butadiene copolymers,
ethylene-vinyl acetate copolymers, and
styrene-acrylate copolymers.

7. The moisture-variable protective layer according to claim 3, wherein the coating composition is a water-based polymer dispersion and the water-based polymer dispersion comprises:
10% to 90% by weight of polymer,
10% to 90% by weight of water,
0% to 80% by weight of filler and pigments, preferably 30% to 80% by weight of fillers and pigments, and
0% to 10% by weight of rheology additives,
based on the water-based polymer dispersion.

8. A process for producing the moisture-variable protective layer according to claim 1 on an insulation material, comprising:
applying the moisture-variable protective layer in liquid form by means of a coating composition to the insulation material or, if present, to a coating of the insulation material.

9. An insulation material having the moisture-variable protective layer according to claim 1, wherein the moisture-variable protective layer is applied in liquid form to the insulation materials by means of a coating composition.

10. An insulation system comprising an insulation material, wherein the insulation material comprises the moisture-variable protective layer according to claim 1, wherein the moisture-variable protective layer is applied in liquid form to the insulation material by means of a coating composition and the insulation system further comprises a further layer applied to the moisture-variable protective layer, selected from the group consisting of an indoor render, paint, tiles, untreated natural stone, mosaics, paneling and wallpaper.

11. The insulation system according to claim 10, wherein the insulation system is free of support constructions.

12. An insulation material including a comprising the moisture-variable protective layer according to claim 8, wherein the insulation material has a thickness of 1 to 30 cm and/or a thermal conductivity lambda of 5 mW/m*K to 60 mW/m*K.

13. A insulation system free of support constructions and other heat bridges that penetrate the insulation layer wherein the insulation system comprises the moisture-variable protective layer according to claim 1.

14. A coating on an insulation render, comprising the moisture-variable protective layer according to claim 1.

15. A method for producing a moisture-variable protective layer, comprising:
applying a coating composition comprising a polymer according to claim 5 to a material.

16. The method according to claim 15, wherein the coating composition is a water-based polymer dispersion and the water-based polymer dispersion comprises:
10% to 90% by weight of polymer,
10% to 90% by weight of water,
0% to 80% by weight of filler and pigments, preferably 30% to 80% by weight of fillers and pigments, and
0% to 10% by weight of rheology additives,
based on the water-based polymer dispersion.
